(19) United States
(12) Patent Application Publication
(10) Pub. No.: US 2025/0301098 A1
(43) Pub. Date: Sep. 25, 2025

(54) IMAGE PROCESSING APPARATUS AND METHOD FOR CONTROLLING IMAGE PROCESSING APPARATUS

(71) Applicant: SHARP KABUSHIKI KAISHA, Sakai City (JP)

(72) Inventor: Masanori MINAMI, Sakai City (JP)

(21) Appl. No.: 19/074,663

(22) Filed: Mar. 10, 2025

(30) Foreign Application Priority Data
Mar. 22, 2024 (JP) 2024-047282

(51) Int. Cl. H04N 1/60

(52) U.S. Cl. CPC H04N 1/6077; H04N 1/6019

(57) ABSTRACT

An image processing apparatus includes one or more processors, an operation acceptor, and a memory. The memory stores a first conversion table and a second conversion table for converting input image data including a first color value into output image data including black and a second color value. The one or more processors perform conversion based on the first conversion table when no instruction for color balance adjustment is input from the operation acceptor. The one or more processors perform conversion based on the second conversion table when an instruction for color balance adjustment is input from the operation acceptor.

### CROSS-REFERENCE TO RELATED APPLICATIONS

The present application claims priority from Japanese Application JP2024-047282, the content of which is hereby incorporated by reference into this application.

### BACKGROUND OF THE INVENTION

### 1. Field of the Invention

The present disclosure relates to an image processing apparatus and a method for controlling the image processing apparatus.

### 2. Description of the Related Art

In general, when an image forming apparatus such as a multi-function printer/peripheral (MFP) or a color printer forms an image represented by input image data on a medium such as paper, image processing is performed to convert the input image data including a first color value (e.g., RGB value) into output image data including black and a second color value (e.g., CMYK values). The image forming apparatus forms an image on a medium based on the output image data.

Although an achromatic color (gray or black) can be expressed by color mixture of CMY toners, a part of the CMY toners can be replaced by using the K toner. By replacing a part of the CMY toners with the K toner, it is possible to suppress the consumption amount of the CMY toners at the time of image formation. For this reason, a color correction table is generally used, in which the CMY values are replaced with the K value at a high rate.

As a conventional technique related to the present disclosure, an image processing apparatus is disclosed, which includes an undercolor remover that performs black plate generation and undercolor removal processing from a color material signal, a spatial filter that performs smoothing processing and edge enhancement, a calculation circuit that calculates ax+b using coefficients a and b for a color material signal x, and a color tone correction controller that performs density adjustment, contrast adjustment, negative-positive reversal, color balance adjustment, and the like.

In the image processing apparatus, the coefficients a and b are set in accordance with a document type and a region identification result. An arithmetic circuit has the plurality of coefficients a and b and is configured to switch the coefficients.

### SUMMARY OF THE INVENTION

There is a case where a user is dissatisfied with the shade of color when viewing an image formed on a medium based on output image data. In such a case, color balance adjustment may be performed to adjust the shade of color by increasing or decreasing CMYK. A conventional image forming apparatus performs color balance adjustment based on a single color correction table. As described above, with a general color correction table, the CMY values are replaced with the K value at a high rate, and therefore, the consumption amount of the CMY toners can be suppressed, while the color balance adjustment is not easily reflected in the output image data, which makes it difficult to perform the color balance adjustment as intended by the user.

An aspect of the present disclosure provides an image processing apparatus and a method for controlling the image processing apparatus that facilitate color balance adjustment.

An image processing apparatus according to an aspect of the present disclosure includes a processor, an operation acceptor, and a memory, the memory stores a first conversion table and a second conversion table for converting input image data including a first color value into output image data including black and a second color value, and the processor performs conversion based on the first conversion table when no instruction for color balance adjustment is input from the operation acceptor and performs conversion based on the second conversion table when an instruction for color balance adjustment is input from the operation acceptor.

A method for controlling an image processing apparatus according to an aspect of the present disclosure includes storing a first conversion table and a second conversion table for converting input image data including a first color value to output image data including black and a second color value, performing conversion based on the first conversion table when no instruction for color balance adjustment is input, and performing conversion based on the second conversion table when an instruction for color balance adjustment is input.

According to an aspect of the present disclosure, it is possible to provide an image processing apparatus that facilitates color balance adjustment.

### BRIEF DESCRIPTION OF THE DRAWINGS

FIG. 1 is an external perspective view of a multi-function printer/peripheral (MFP) according to a first embodiment of the present disclosure.

FIG. 2 is a functional block diagram of the MFP according to the first embodiment of the present disclosure.

FIG. 3 is a diagram illustrating an image processor of the MFP according to the first embodiment of the present disclosure.

FIG. 4 is a diagram illustrating an example of an operation screen of a color balance function displayed on a display of the MFP according to the first embodiment of the present disclosure.

FIGS. 5A to 5D are graphs illustrating an example of a conversion curve for increasing or decreasing cyan, magenta, yellow, and black (CMYK) set on the operation screen of FIG. 4, wherein FIG. 5A illustrates an example of a conversion curve for C toner, FIG. 5B illustrates an example of a conversion curve for M toner, FIG. 5C illustrates an example of a conversion curve for Y toner, and FIG. 5D illustrates an example of a conversion curve for K toner.

FIG. 6 is a conceptual schematic diagram illustrating the relationship between the CMYK toners used for printing and the color reproduced on paper.

FIG. 7 is a conceptual schematic diagram illustrating that the CMY toners of ideal subtractive color mixture can be replaced with the K toner.

FIG. 8 is a conceptual schematic diagram illustrating that, since the same amount of CMY toners and the same amount of K toner can be replaced with each other in the ideal subtractive color mixture, even when a part of the CMY toners is replaced with the corresponding amount of K toner, the color development on the paper does not change.

FIG. 9 is a conceptual schematic diagram illustrating that the amount of change in the shade of color is small even when the CMY toner amounts are increased for color balance adjustment in the case where the amount of K toner is large as compared with the case where the amount of K toner is small.

FIG. 10 is a conceptual schematic diagram illustrating a difference between a case where color conversion is performed using a normal color correction table and a case where color conversion is performed using a color correction table for color balance adjustment in the MFP according to the first embodiment of the present disclosure.

FIGS. 11A and 11B are conceptual schematic diagrams illustrating the flow of data processing in the MFP according to the first embodiment of the present disclosure, wherein FIG. 11A is a diagram illustrating a case where color conversion is performed using the normal color correction table, and FIG. 11B is a diagram illustrating data processing in the case of performing color conversion using the color correction table for color balance adjustment. FIG. 12 is a flowchart illustrating an operation of the MFP according to the first embodiment of the present disclosure.

FIG. 13 is a diagram illustrating input image data to be color-converted in the MFP according to the second embodiment of the present disclosure.

FIG. 14 is a flowchart illustrating an operation of the MFP according to the second embodiment of the present disclosure.

FIGS. 15A to 15C are conceptual schematic diagrams illustrating a flow of data processing in the MFP according to a third embodiment of the present disclosure, wherein FIG. 15A is a diagram illustrating a case where color conversion is performed using a normal color correction table, FIG. 15B is a diagram illustrating data processing when color conversion is performed using a first color correction table (look-up table (LUT)) for color balance adjustment, and FIG. 15C is a diagram illustrating data processing when color conversion is performed using a second color correction table (LUT) for color balance adjustment.

FIG. 16 is a flowchart illustrating an operation of the MFP according to the third embodiment of the present disclosure.

FIG. 17 is a diagram illustrating an example of a screen on which an LUT change notification for notifying the user that the color correction table has been changed is displayed in a superimposed manner on an operation screen of a color balance function in FIG. 4.

### DETAILED DESCRIPTION OF THE INVENTION

### 1. First Embodiment

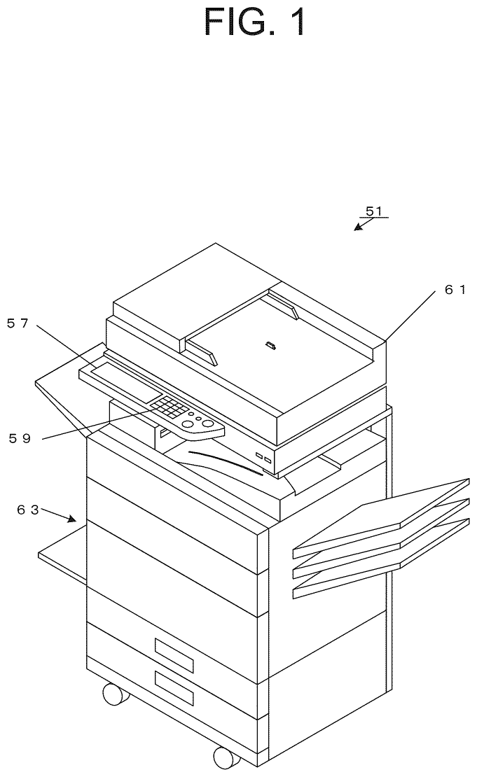

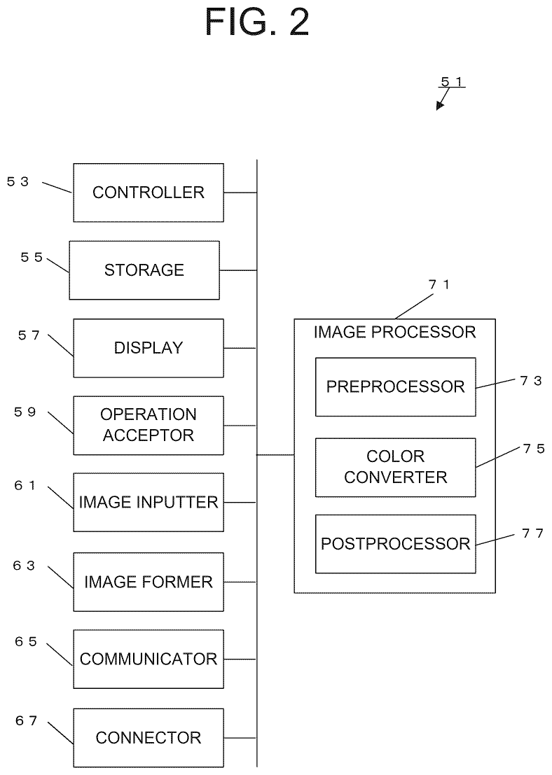

FIG. 1 is an external perspective view of an MFP 51 according to a first embodiment of the present disclosure. FIG. 2 is a functional block diagram of the MFP 51 according to the first embodiment of the present disclosure. The MFP, also called a multi-function printer/peripheral, is a kind of image forming apparatus and typically has a copy function, an image scanner function, a facsimile function, and a printer function. The MFP 51 may further have other functions, for example, an e-mail transmission and reception function or a file server function. The MFP 51 includes a controller 53, a storage 55, a display 57, an operation acceptor 59, an image inputter 61, an image former 63, a communicator 65, a connector 67, and an image processor 71.

The controller 53 controls the entire MFP 51. The controller 53 includes one or more control devices or control circuits and includes, for example, a central processing unit (CPU), which is a processor that executes various kinds of arithmetic processing, or a system on a chip (SoC).

The controller 53 reads a program stored in the storage 55 and executes processing and thus can perform each function. In other words, the MFP 51 includes a processor that operates in accordance with a program, for example, a CPU, as a main hardware configuration. The processor may be of any type as long as the processor executes a program so as to perform a function. The processor includes one or more electronic circuits including a semiconductor integrated circuit, for example, an integrated circuit (IC) or large scale integration (LSI). The plurality of electronic circuits may be integrated in one chip or may be provided in a plurality of chips. The plurality of chips may be integrated into one device or may be provided in a plurality of devices.

The storage 55 stores various programs and various types of data necessary for the operation of the MFP 51. The storage 55 includes one or more recording devices capable of transitory storage such as a dynamic random access memory (DRAM) or non-transitory recording devices such as a solid state drive (SSD) configured by a semiconductor memory or a hard disk drive (HDD) configured by a magnetic disk. Although the storage 55 is configured as a single unit for convenience of description, the storage 55 may be configured as a separate device for each use, such as an area used for execution of a program (main storage area), an area for storing a program or data (auxiliary storage area), or an area used for cache.

The display 57 displays images and characters. For example, the display includes a liquid crystal display (LCD) or an organic electro-luminescence (EL) panel. The display 57 may be a single display device or may further include a display device connected to the outside.

The operation acceptor 59 accepts an operation input from a user. For example, the operation acceptor 59 includes a hardware key and/or a software key. The operation acceptor 59 includes operation keys such as a task key for giving an instruction to execute a task such as FAX transmission or image reading, and a cancel key for giving an instruction to cancel an operation.

The image inputter 61 reads an image (document) and outputs the read image as image data. The image inputter 61 includes a general color scanner (image input device). The image inputter 61 may receive image data from an external storage medium such as a USB memory, or may receive an image via a network.

The image former 63 forms (prints) an image on a medium such as a copy sheet based on image data. The image former 63 may use any printing method and may be, for example, any one of an inkjet printer, a laser printer, or a thermal transfer printer. The image former 63 is a color printer. The image former 63 may include a paper feed mechanism that feeds a medium, a transport mechanism that transports a medium, a sorter mechanism that sorts a medium on which an image has been formed, and the like.

The communicator 65 is connected to a network. For example, the communicator 65 includes an interface connectable to a wired local area network (LAN), a wireless LAN, or a long term evolution (LTE) network. When the communicator 65 is connected to the network, the communicator 65 is connected to another device or an external network. The communicator 65 may be, for example, an interface that performs short-range wireless communications such as near field communication (NFC) or Bluetooth (registered trademark).

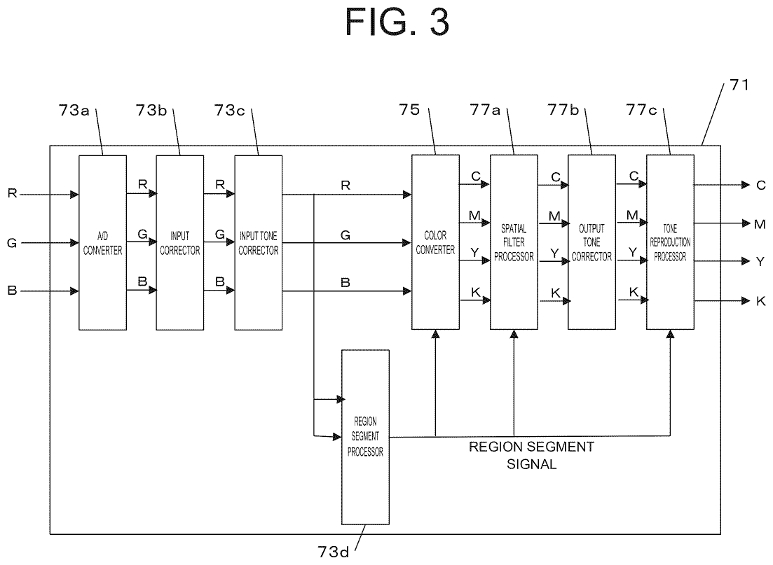

The connector 67 connects the MFP 51 and other devices. For example, the connector 67 is a USB interface, and a USB memory or the like is connected thereto. Further, the connector 67 may be an interface such as HDMI (registered trademark) other than the USB interface. FIG. 3 is a diagram illustrating the image processor 71 of the MFP according to the first embodiment of the present disclosure. The image processor 71 includes a preprocessor 73, a color converter 75, and a postprocessor 77. The preprocessor 73 includes an analog/digital (A/D) converter 73a, an input corrector 73b, an input tone corrector 73c, and a region segment processor 73d. The image processor 71 includes a spatial filter processor 77a, an output tone corrector 77b, and a tone reproduction processor 77c as the postprocessor 77. An analog signal read by the image inputter 61 is sent to the A/D converter 73a, the input corrector 73b, the input tone corrector 73c, the region segment processor 73d, the color converter 75, the spatial filter processor 77a, the output tone corrector 77b, and the tone reproduction processor 77c in this order in the image processor 71 and is output to the image former 63 as a CMYK digital color signal. Some or all of the preprocessor 73, the color converter 75, and the postprocessor 77 may be configured by an electronic circuit. Alternatively, the preprocessor 73, the color converter 75, and the postprocessor 77 may be implemented when the controller 53 reads and executes a program from the storage 55.

The A/D converter 73a converts an analog signal into a digital signal. The input corrector 73b performs shading correction, gamma correction, line delay correction, modulation transfer function (MTF) correction processing, and the like, on the digital RGB signals sent from the A/D converter 73a. The input tone corrector 73c performs image quality adjustment processing such as removal of background density and contrast.

The region segment processor 73d segments each pixel in the input image into any one of a character region, a halftone dot region, and a photograph region based on RGB signals. Based on the segmentation result, the region segment processor 73d outputs the region identification signal indicating the region to which the pixel belongs to the color converter, the spatial filter processor, and the tone reproduction processor, and outputs the input signal output from the input tone corrector to the color converter in the subsequent stage as it is. The color converter 75 performs a process to remove color turbidity based on spectral characteristics of cyan, magenta, yellow, and black (CMYK) color materials including unnecessary absorption components in order to realize faithful color reproduction.

The spatial filter processor 77a performs spatial filtering processing on image data of CMYK signals input from the color converter 75 by using a digital filter based on the region identification signal to correct the spatial frequency characteristics, thereby preventing blurring and graininess deterioration of an output image. The spatial filter processor 77a performs low-pass filter processing to remove an input halftone dot component on the region that is segmented into the halftone dot region by the region segment processor 73d.

The output tone corrector 77b performs output tone correction processing to convert a signal such as a density signal into a halftone dot area ratio that is a characteristic value of the image former 63, and then the tone reproduction processor 77c performs tone reproduction processing (halftone generation) to finally segment an image into pixels and reproduce the respective tones. A region segmented into a photograph by the region segment processor 73d is subjected to binarization processing or multivalued processing using a screen that emphasizes tone reproducibility.

Similarly to the spatial filter processor 77a, the tone reproduction processor 77c performs predetermined processing on the image data of CMYK signals based on the region identification signal. For example, in the region segmented into a character by the region segment processor 73d, the amount of enhancement of the high frequency is increased in the sharpness enhancement processing in the spatial filter processing by the spatial filter processor in order to enhance the reproducibility of a black character or color character in particular. At the same time, in the tone reproduction processor 77c, binarization or multivalued processing using a high-resolution screen suitable for high-frequency reproduction is selected.

The image data subjected to each processing of the image processor 71 described above is temporarily stored in the storage 55, read out at a predetermined timing, and input to the image former 63. For example, an RGB image obtained by scanning a document by the image inputter 61 using the copy function of the MFP 51 is converted into a CMYK image by processing in the color converter 75, and an image is formed on a medium by the image former 63.

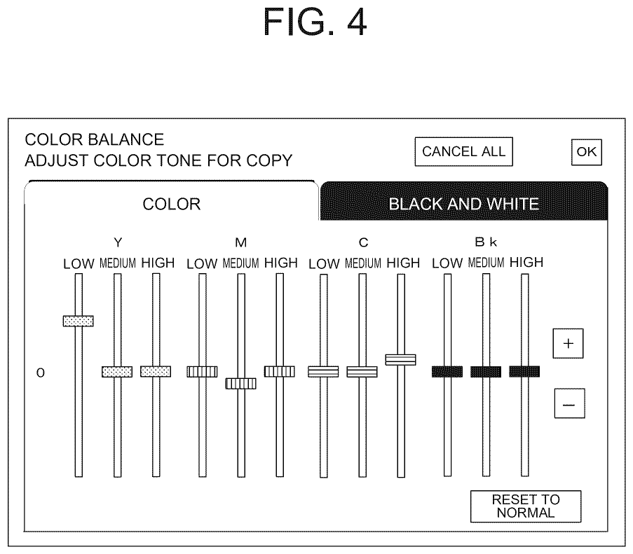

FIG. 4 is a diagram illustrating an example of an operation screen of a color balance function displayed on the display 57 of the MFP (multi-function printer/peripheral) according to the first embodiment of the present disclosure. In FIG. 4, K is represented as Bk. On this operation screen, three slide bars of low density, medium density, and high density are provided for each of CMYK. Thus, for example, the density can be increased or decreased for each of the low density, the medium density, and the high density of C. The same applies to MYK.

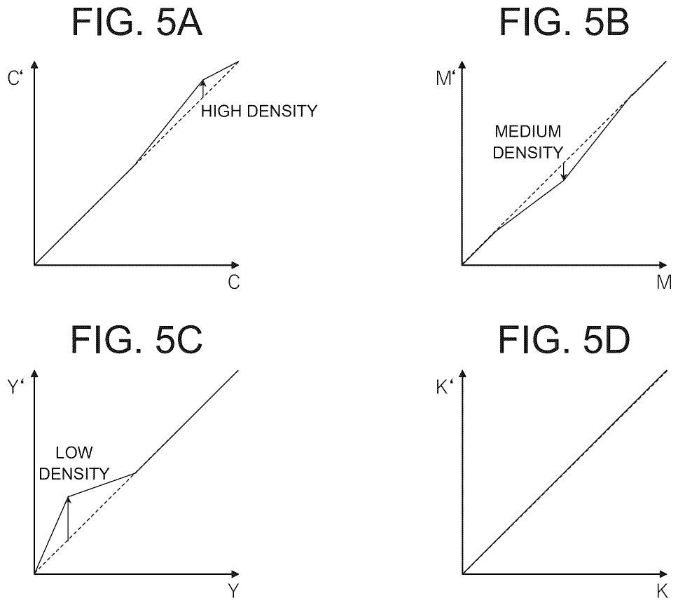

FIGS. 5A to 5D are graphs illustrating an example of a conversion curve for increasing or decreasing CMYK (cyan, magenta, yellow, and black) set on the operation screen of FIG. 4. FIG. 5A illustrates an example of a conversion curve for C toner, FIG. 5B illustrates an example of a conversion curve for M toner, FIG. 5C illustrates an example of a conversion curve for Y toner, and FIG. 5D illustrates an example of a conversion curve for K toner. As illustrated in FIG. 4, the positions of the slide bars of the low density, the medium density, and the high density of CMYK are moved to the positions where the low density of the Y toner is high, the medium density of the M toner is slightly low, the high density of the C toner is slightly high, and the K toner is not changed. Accordingly, as illustrated in FIGS. 5A to 5D, for each of the CMYK toners, a conversion curve for changing the density of low density, medium density, and high density is set.

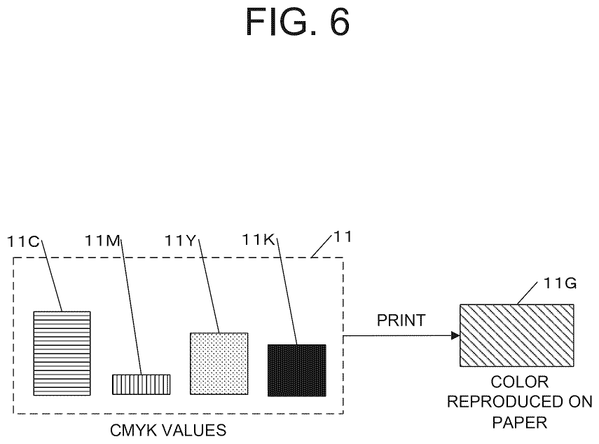

FIG. 6 is a conceptual schematic diagram illustrating the relationship between the CMYK toners used for printing and the color reproduced on paper (medium). By printing the CMYK toners on the paper in a superimposed manner, the color corresponding to the amount of each of CMYK is reproduced on the paper. By changing the CMYK amounts, a desired color can be reproduced. FIG. 6 illustrates that, when the CMYK toners represented by a C toner amount 11C, an M toner amount 11M, a Y toner amount 11Y, and a K toner amount 11K are applied to the same region on the paper, a green color is reproduced on the paper as a result of the subtractive color mixture.

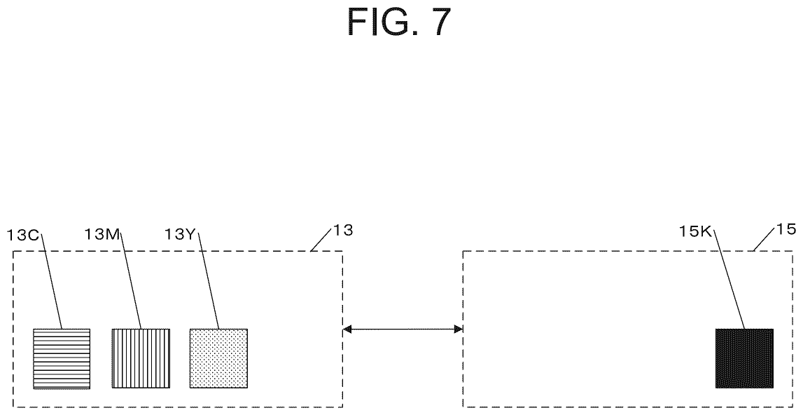

FIG. 7 is a conceptual schematic diagram illustrating that the CMY toners of ideal subtractive color mixture can be replaced with the K toner. A C toner amount 13C, an M toner amount 13M, and a Y toner amount 13Y are equal to one another. When the same amounts of CMY toners are subjected to ideal subtractive color mixing, a gray 15K is reproduced on the paper. Therefore, the same amount of CMY toners can be replaced with the same amount of K toner. In other words, the amount of C toner, M toner, and Y toner represented as 1:1:1 can be replaced with the corresponding amount of K toner. Since the characteristics of the actual toner are different from those of the ideal toner, the CMY toner amounts and the K toner amount which can be replaced are not C:M:Y:K=1:1:1:1, but a person skilled in the art can obtain the ratio between the CMY toner amounts and the K toner amount which can be replaced in the actual toner in the same manner.

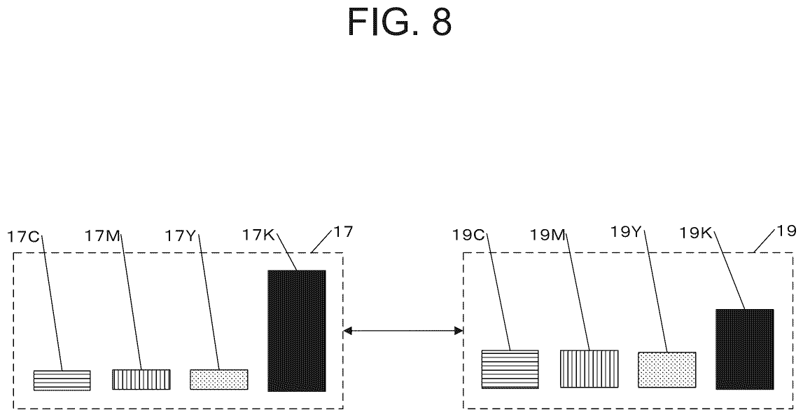

FIG. 8 is a conceptual schematic diagram illustrating that, since the same amount of CMY toners and the same amount of K toner can be replaced with each other in the ideal subtractive color mixture, even when a part of the CMY toners is replaced with the corresponding amount of K toner, the color development on the paper does not change. As illustrated in the figure, the amounts of CMYK toners are different from each other between a toner amount 17 and a toner amount 19. However, there is a relationship such that, in the toner amount 17, a toner amount 17K is decreased and, by the corresponding amount, CMYK toner amounts 17C, 17M, and 17Y are increased, and thus toner amounts 19C, 19M, 19Y, and 19K of the toner amount 19 are obtained. Therefore, according to the image formation using the toner amount 17 and the image formation using the toner amount 19, the same color is reproduced on the paper in both cases.

As illustrated in FIG. 8, there is a plurality of combinations of CMYK toner amounts with which the same color is reproduced on the paper. These combinations of toner amounts are different from each other from the viewpoint of easiness of color balance adjustment.

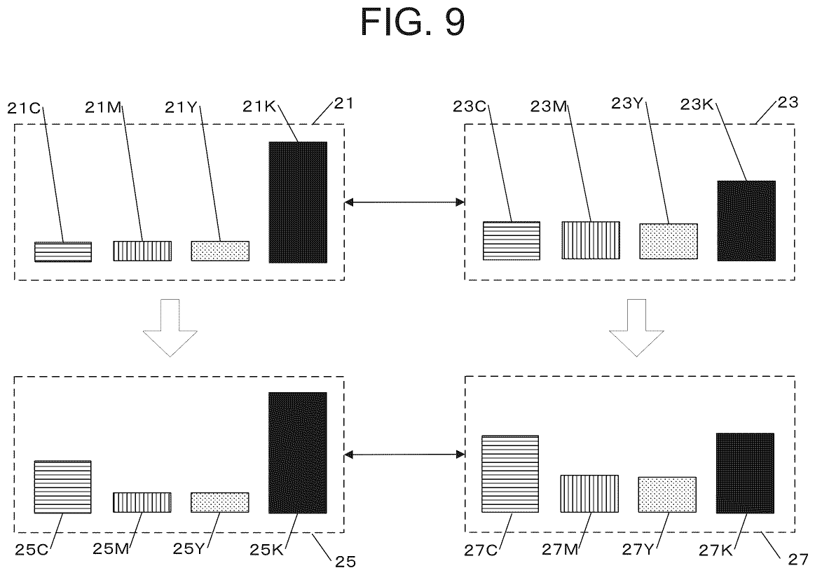

FIG. 9 is a conceptual schematic diagram illustrating that the amount of change in the shade of color is small even when the CMY toner amounts are increased for color balance adjustment in the case where the amount of K toner is large as compared with the case where the amount of K toner is small. Toner amounts 21 and 23 are CMYK toner amounts for reproducing the same color on the paper. A toner amount 25 is obtained by increasing only the C toner amount in the toner amount 21. That is, a C toner amount 25C is larger than a C toner amount 21C. An M toner amount 25M, a Y toner amount 25Y, and a K toner amount 25K are equal to an M toner amount 21M, a Y toner amount 21Y, and a K toner amount 21K, respectively.

Similarly, a toner amount 27 is obtained by increasing only the C toner amount in the toner amount 23. That is, a C toner amount 27C is larger than a C toner amount 23C. An M toner amount 27M, a Y toner amount 27Y, and a K toner amount 27K are equal to an M toner amount 23M, a Y toner amount 23Y, and a K toner amount 23K, respectively.

Here, it is assumed that the difference between the C toner amount 25C and the C toner amount 21C is equal to the difference between the C toner amount 27C and the C toner amount 23C, and both are changed by a change amount D, and the ratio of the change amount D of the C toner amount to the K toner amount is compared between the toner amount 25 and the toner amount 27. In the case of the toner amount 25, the K toner amount 25K is larger than the K toner amount 27K. Therefore, the ratio of the change amount D of the C toner amount to the K toner amount is smaller in the toner amount 25 and larger in the toner amount 27.

This means that, when the amount of C toner is changed by the same amount, the saturation of the color reproduced on the paper is larger in the toner amount 27. In the case of the toner amount 25, since the K toner amount 25K is large with respect to the change amount D of the C toner amount, the change due to the change amount D of the C toner amount is buried by the influence of the K toner, and the shade of color does not change. Conversely, in the case of the toner amount 27, since the K toner amount 27K is small with respect to the change amount D of the C toner amount, the change due to the change amount D is unlikely to be affected by the K toner, and as a result, the saturation of the color reproduced on the paper can be largely changed.

In view of this, the image processing apparatus according to the present disclosure includes a color correction table for color balance adjustment in addition to a normal color correction table. When processing other than color balance adjustment is performed, color conversion is performed by using the former table, and when color balance adjustment is performed, color conversion is performed by using the latter table.

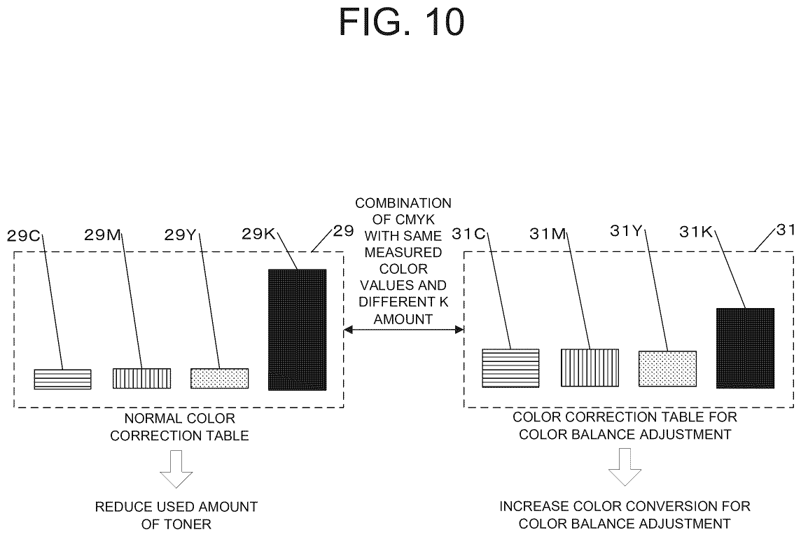

FIG. 10 is a conceptual schematic diagram illustrating a difference between a case where color conversion is performed using the normal color correction table and a case where color conversion is performed using the color correction table for color balance adjustment in the MFP 51 according to the first embodiment of the present disclosure. Toner amounts 29 and 31 are combinations of CMYK toner amounts for reproducing the same color on the paper.

In the case of processing other than color balance adjustment, the image processor 71 performs color conversion by using the normal color correction table and acquires CMYK toner amounts 29C, 29M, 29Y, and 29K indicated by the toner amount 29. In this case, the used amount of CMY toners can be suppressed.

Conversely, in the case of color balance adjustment, the image processor 71 performs color conversion using the color correction table for color balance adjustment and acquires CMYK toner amounts 31C, 31M, 31Y, and 31K indicated by the toner amount 31. In this case, the used amounts of the CMY toners increase, and the used amount of the K toner decreases. As a result, the amount of change in the CMY toners with respect to the amount of K toner increases, and therefore the shade of color can be easily changed.

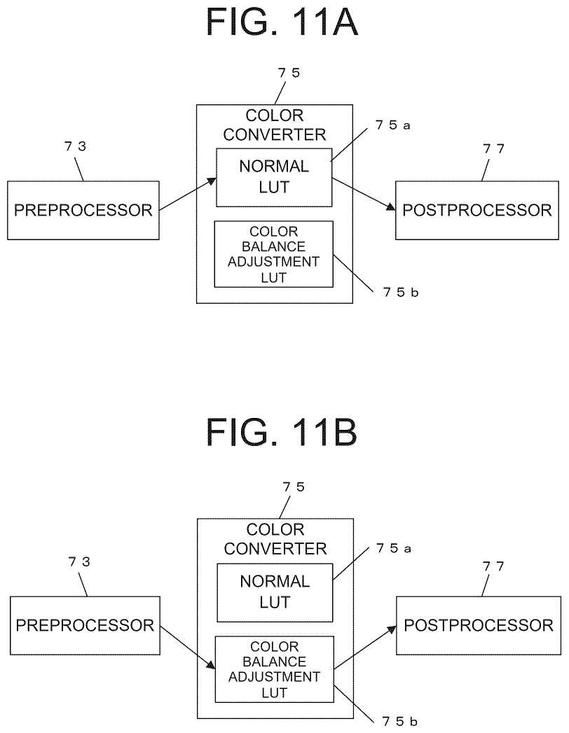

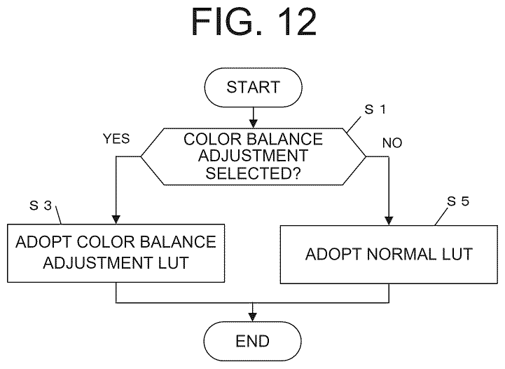

FIGS. 11A and 11B are conceptual schematic diagrams illustrating the flow of data processing in the MFP 51 according to the first embodiment of the present disclosure. The color converter 75 stores a normal look-up table (LUT) 75a used for processing other than color balance adjustment and a color balance adjustment LUT 75b used for color balance adjustment. The normal LUT 75a is also referred to as a first conversion table. The color balance adjustment LUT 75b is also referred to as a second conversion table.

FIG. 11A is a diagram illustrating a case where color conversion is performed using the normal color correction table. In the case of processing other than color balance adjustment, the color converter 75 performs color conversion based on the normal LUT 75a.

FIG. 11B is a diagram illustrating data processing in the case of performing color conversion using the color correction table for color balance adjustment. In the case of color balance adjustment, the color converter 75 performs color conversion based on the color balance adjustment LUT 75b. The normal LUT 75a is a table in which the CMY amounts are small and the K amount is large as compared with the color balance adjustment LUT 75b. Conversely, the color balance adjustment LUT 75b is a table in which the CMY amounts are large and the K amount is small as compared with the normal LUT 75a.

FIG. 12 is a flowchart illustrating an operation of the MFP 51 according to the first embodiment of the present disclosure. The controller 53 determines whether an operation for giving an instruction to execute color balance adjustment (an instruction for color balance adjustment) has been performed from the operation acceptor 59 (step S1). When the operation for giving an instruction to execute color balance adjustment has been performed (Yes in step S1), the controller 53 gives an instruction to the image processor 71 to execute color conversion processing using the color balance adjustment LUT 75b (step S3). When the operation for giving an instruction to execute color balance adjustment has not been performed (No in step S1), the controller 53 gives an instruction to the image processor 71 to execute color conversion processing using the normal LUT 75a (step S5).

According to the present embodiment, color conversion is performed using the normal LUT 75a in processing other than color balance adjustment. Since the normal LUT 75a is a table in which the CMY amounts are small and the K amount is large, the consumption of the CMY toner amounts can be suppressed. Conversely, in the color balance adjustment, color conversion is performed using the color balance adjustment LUT 75b. Since the color balance adjustment LUT 75b is a table in which the CMY amounts are large and the K amount is small, the change amount of the CMY amounts becomes large with respect to the K amount, and as a result, the shade of color can be easily changed, and the adjustment intended by the user can be easily performed.

### 2. Second Embodiment

A second embodiment will be described. According to the first embodiment, either the normal LUT 75a or the color balance adjustment LUT 75b is selected depending on whether the operation for giving an instruction to execute the color balance adjustment has been performed. Comapred with the first embodiment, according to the second embodiment, either the normal LUT 75a or the color balance adjustment LUT 75b is selected based on the input image data in addition to whether the operation for giving an instruction to execute the color balance adjustment has been performed. Differences in the configuration and processing from the first embodiment will be mainly described below.

In general, for a color having high brightness or a color having high saturation, the total CMY amount is small, or even when the total CMY amount is large, the minimum toner amount among the CMY toner amounts is small. When the total CMY amount is small, the amount of CMY toners that can be replaced with K toner is also necessarily small. Further, when the minimum toner amount among the CMY toner amounts is small, the CMY toners are replaced with the K toner on the basis of the minimum toner amount, so that the amount of the CMY toners which can be replaced with the K toner becomes small. Therefore, it is not necessary to perform color conversion using the color balance adjustment LUT 75b as described in the first embodiment on a pixel having high brightness or an image having high saturation. The present embodiment takes this into consideration.

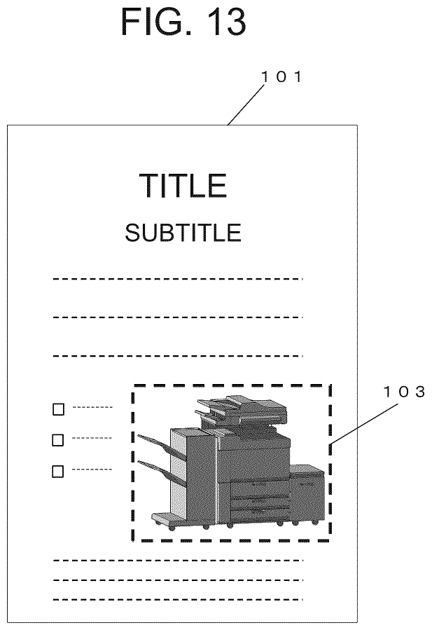

FIG. 13 is a diagram illustrating input image data to be color-converted in the MFP 51 according to the second embodiment of the present disclosure. Input image data 101 includes a region (character region) in which a character is drawn and a non-character region 103 which is a region in which a photograph is drawn instead of a character. According to the second embodiment, when an operation for giving an instruction to execute color balance adjustment is performed and the number of gray pixels in the non-character region 103 exceeds a threshold, color conversion is performed using the color balance adjustment LUT 75b.

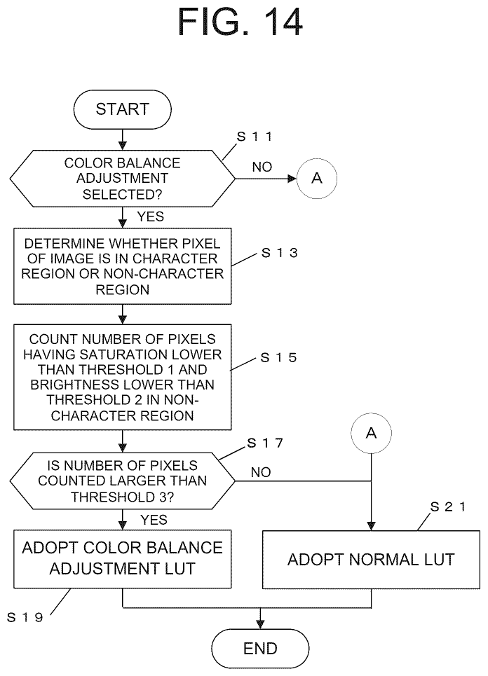

FIG. 14 is a flowchart illustrating an operation of the MFP 51 according to the second embodiment of the present disclosure. The controller 53 determines whether an operation for giving an instruction to execute color balance adjustment has been performed from the operation acceptor 59 (step S11). When the operation for giving an instruction to execute the color balance adjustment has been performed (Yes in step S11), the controller 53 determines whether each pixel of the input image data is a pixel in the character region or the non-character region (step S13). Subsequently, the controller 53 counts the number of pixels having a saturation lower than threshold 1 and a brightness lower than threshold 2 in the non-character region (step S15). The threshold 1 is for example 5, and the threshold 2 is for example 80. Subsequently, the controller 53 determines whether the number of pixels counted in step S15 is larger than threshold 3 (step S17). The threshold 3 is for example 10% of the total number of pixels (4905587 pixels in A4 size of 600 dpi). When the number of pixels counted in step S15 is larger than the threshold 3 (Yes in step S17), an instruction is given to the image processor 71 to execute color conversion processing using the color balance adjustment LUT 75b (step S9). When the operation for giving an instruction to execute the color balance adjustment has not been performed (No in step S11), and when the number of pixels counted in step S15 is equal to or less than the threshold 3 (No in step S17) even when the operation for giving an instruction to execute the color balance adjustment has been performed (Yes in step S11), the controller 53 gives an instruction to the image processor 71 to execute the color conversion processing using the normal LUT 75a (step S21).

According to the second embodiment, the color conversion is executed by selecting either the normal LUT 75a or the color balance adjustment LUT 75b in accordance with whether the operation for giving an instruction to execute the color balance adjustment is performed and the number of pixels of colors close to gray in the non-character region of the input image, and the process of switching the color correction LUT can be omitted when there are many pixels having a small amount of K toner.

### 3. Third Embodiment

A third embodiment will be described. According to the first embodiment, when an operation for giving an instruction to execute the color balance adjustment is performed, color conversion is executed based on a predetermined table (the color balance adjustment LUT 75b). Comapred with the first embodiment, according to the third embodiment, a plurality of tables is prepared, which is used when an operation for giving an instruction to execute color balance adjustment is performed, one of the tables is selected in accordance with a user operation, and color conversion is executed using the selected table. Hereinafter, only differences in the configuration and processing from the first embodiment will be mainly described.

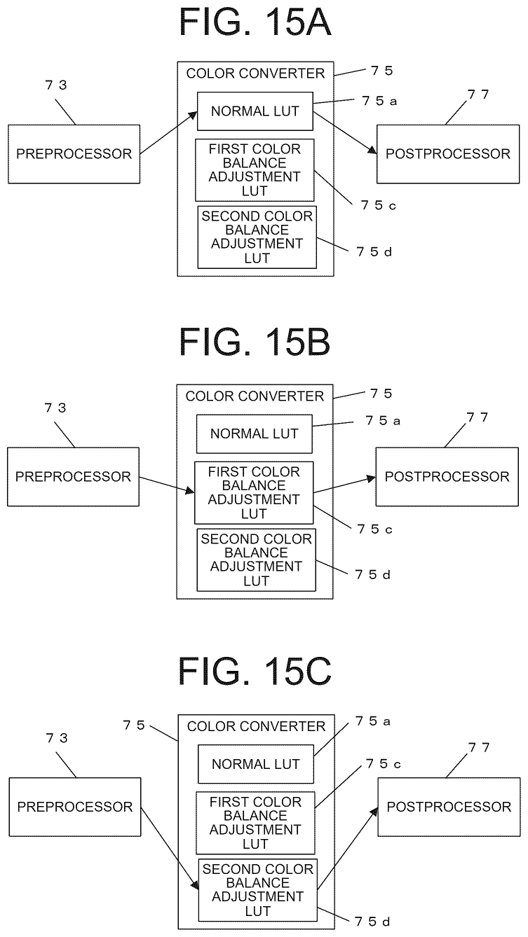

FIGS. 15A to 15C are conceptual schematic diagrams illustrating a flow of data processing in the MFP according to the third embodiment of the present disclosure. According to the third embodiment, the color converter 75 includes two color balance adjustment LUTs, i.e., a first color balance adjustment LUT 75c and a second color balance adjustment LUT 75d, in addition to the normal LUT 75a. FIG. 15A is a diagram illustrating a case where color conversion is performed using the normal LUT 75a. FIG. 15B is a diagram illustrating data processing when color conversion is performed using the first color balance adjustment LUT 75c. FIG. 15C is a diagram illustrating data processing when color conversion is performed using the second color balance adjustment LUT 75d. The first color balance adjustment LUT 75c and the second color balance adjustment LUT 75d are also referred to as a second conversion table.

The normal LUT 75a is a table in which the CMY amounts are small and the K amount is large as compared with the first color balance adjustment LUT 75c and the second color balance adjustment LUT 75d. The first color balance adjustment LUT 75c is a table in which the CMY amounts are large and the K amount is small as compared with the normal LUT 75a. The second color balance adjustment LUT 75d is a table in which the CMY amounts are large and the K amount is small as compared with both the normal LUT 75a and the first color balance adjustment LUT 75c.

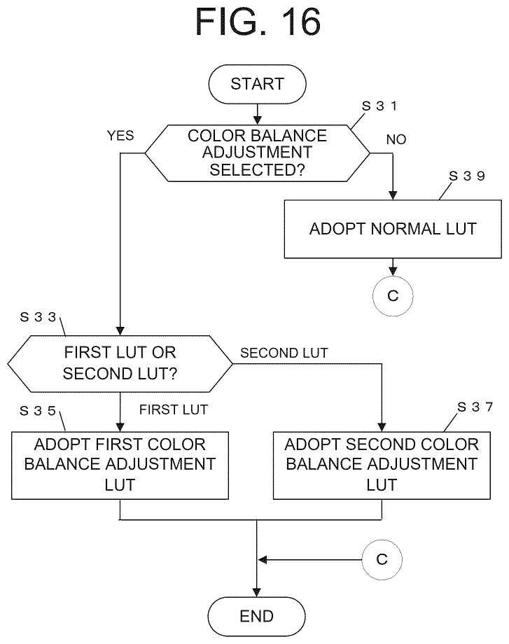

FIG. 16 is a flowchart illustrating an operation of the MFP 51 according to the third embodiment of the present disclosure. The controller 53 determines whether an operation for giving an instruction to execute color balance adjustment has been performed from the operation acceptor 59 (step S31). When the operation for giving an instruction to execute the color balance adjustment has been performed (Yes in step S31), the controller 53 determines which of the first color balance adjustment LUT 75c and the second color balance adjustment LUT 75d has been selected by the operation via the operation acceptor 59 (step S33).

When it is determined that the first color balance adjustment LUT 75c has been selected (the first LUT in step S33), the controller 53 gives an instruction to the image processor 71 to execute the color conversion processing using the first color balance adjustment LUT 75c (step S35). When it is determined that the second color balance adjustment LUT 75d has been selected (the second LUT in step S33), the controller 53 gives an instruction to the image processor 71 to execute the color conversion processing using the second color balance adjustment LUT 75d (step S37).

In step S31, when it is determined that the operation for giving an instruction to execute the color balance adjustment has not been performed from the operation acceptor 59, the controller 53 gives an instruction to the image processor 71 to execute the color conversion processing using the normal LUT 75a (step S39).

In the above description, the operation of selecting either the first color balance adjustment LUT 75c or the second color balance adjustment LUT 75d is performed via the operation acceptor 59 in step S33. Instead, the controller 53 may cause the display 57 to display a screen for inquiring the degree of change in the shade of color desired by the user when the color balance adjustment is performed and may cause the user to input the magnitude of the change in the shade of color via the operation acceptor 59 as a response. At this time, when the user desires a smaller change in the shade of color, the controller 53 determines that the first LUT has been selected in step S33, and when the user desires a larger change in the shade of color, the controller 53 determines that the second LUT has been selected in step S33.

### 4. Modification

The present disclosure is not limited to the above-described embodiments and modification, and various changes can be made. That is, an embodiment obtained by combining technical measures appropriately changed within the scope without departing from the gist of the present disclosure is also included in the technical scope of the present disclosure.

According to the above-described embodiment, the normal LUT 75a, the color balance adjustment LUT 75b, the first color balance adjustment LUT 75c, and the second color balance adjustment LUT 75d are stored in the color converter 75; however, these tables may be stored in the storage 55. In this case, the color converter 75 reads a desired table from the storage 55 as necessary.

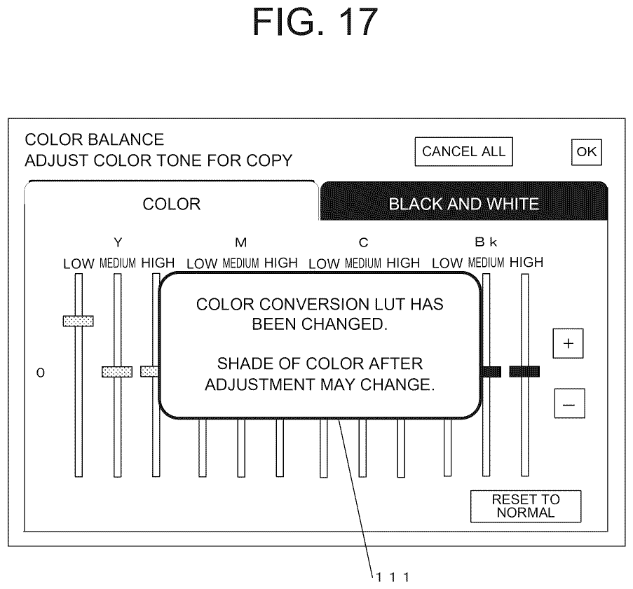

According to the above-described embodiment, the user is not explicitly notified that the color balance adjustment LUT has been adopted. However, after the selection of the color correction LUT is changed, there is a possibility that the shade of color of the image formed on the medium changes due to the change of the table, and thus, there is a concern that the user may be confused. In order to avoid this confusion, a message for warning that there is a possibility that the color correction LUT has been changed and a change has occurred in the shade of color may be displayed on the screen as in an LUT change notification 111 of FIG. 17. FIG. 17 is a diagram illustrating an example of a screen on which the LUT change notification for notifying the user that the color correction table has been changed is displayed in a superimposed manner on the operation screen of the color balance function in FIG. 4. In the example of FIG. 17, the LUT change notification 111 is displayed in a superimposed manner on the operation screen of the color balance function of FIG. 4. The LUT change notification 111 may be displayed as a screen different from the operation screen of the color balance function in FIG. 4. By displaying the LUT change notification 111, it is possible to warn the user that there is a possibility that the shade of color of the image formed on the medium changes.

A program that operates in each device according to the embodiment is a program (a program that causes a computer to function) that controls a CPU or the like so as to perform the functions according to the above-described embodiment. Information handled by these devices is temporarily stored in a temporary storage device (for example, RAM) at the time of processing, and is then stored in a storage device such as various read only memories (ROMs) or an HDD, and is read, modified, or written by the CPU as necessary.

Here, the recording medium that stores the program may be any of a semiconductor medium (e.g., a ROM or a nonvolatile memory card), an optical recording medium/magneto-optical recording medium (e.g., a digital versatile disc (DVD), a magneto optical disc (MO), a mini disc (MD), a compact disc (CD), or a Blu-ray (BD) (registered trademark) Disc), a magnetic recording medium (for example, a magnetic tape or a flexible disk), or the like. Further, not only the functions according to the above-described embodiments are performed by executing the loaded program, but also the functions according to the present disclosure may be performed by performing processing in cooperation with an operating system, another application program, or the like, on the basis of instructions of the program.

In a case where the program is distributed in the market, the program can be stored in a portable recording medium and distributed, or can be transferred to a server computer connected via a network such as the Internet. In this case, of course, the storage device of the server computer is also included in the present disclosure.

While there have been described what are at present considered to be certain embodiments of the invention, it will be understood that various modifications may be made thereto, and it is intended that the appended claims cover all such modifications as fall within the true spirit and scope of the invention.

What is claimed is:

1. An image processing apparatus comprising one or more processors, an operation acceptor, and a memory, wherein
the memory stores a first conversion table and a second conversion table for converting input image data including a first color value into output image data including black and a second color value, and
the one or more processors
perform conversion based on the first conversion table when no instruction for color balance adjustment is input from the operation acceptor, and
perform conversion based on the second conversion table when an instruction for color balance adjustment is input from the operation acceptor.

2. The image processing apparatus according to claim 1, wherein the one or more processors
distinguish between a character region and a non-character region in the input image data, and
perform conversion based on any one of the first conversion table and the second conversion table selected based on the number of pixels in the non-character region when an instruction for color balance adjustment is input from the operation acceptor.

3. The image processing apparatus according to claim 2, wherein the one or more processors perform the selection based on saturation and brightness of a pixel in the non-character region.

4. The image processing apparatus according to claim 1, wherein
the second conversion table stored in the memory includes a plurality of second conversion tables, and
when an instruction for color balance adjustment is input from the operation acceptor, the one or more processors perform conversion based on any one of the plurality of second conversion tables selected based on the instruction.

5. The image processing apparatus according to claim 2, wherein when an instruction for color balance adjustment is input from the operation acceptor, the one or more processors perform conversion based on any one of the first conversion table and the second conversion table selected based on the number of gray pixels in the non-character region.

6. A method for controlling an image processing apparatus executed by one or more processors, the method comprising:
storing a first conversion table and a second conversion table for converting input image data including a first color value to output image data including black and a second color value;
performing conversion based on the first conversion table when no instruction for color balance adjustment is input; and
performing conversion based on the second conversion table when an instruction for color balance adjustment is input.
